(19) United States
(12) Patent Application Publication
(10) Pub. No.: US 2016/0020809 A1
(43) Pub. Date: Jan. 21, 2016

(54) GRIPPING ACCESSORY FOR HANDHELD DEVICES

(71) Applicant: JOSLIN PRODUCTS, INC., DBA JOSLIN ORTHOPEDIC GEAR, San Diego, CA (US)

(72) Inventor: Mandy Joslin, San Diego, CA (US)

(21) Appl. No.: 14/517,785

(22) Filed: Oct. 17, 2014

Related U.S. Application Data
(63) Continuation-in-part of application No. 14/333,445, filed on Jul. 16, 2014.

(51) Int. Cl. H04B 1/3888

(52) U.S. Cl. CPC H04B 1/3888; H04B 2001/3861

(57) ABSTRACT

An accessory for a device defining a medial-lateral X direction, a proximal-distal Y direction generally transverse to the X direction, and an anterior-posterior Z direction generally transverse to the X and Y directions. The accessory includes a main body defining a substantially flat posterior surface in an X-Y plane, the surface being configured for attachment to the device. In a plan view when viewed from the Z direction, the main body defines a shape which includes a first concave edge at a first lateral side of the accessory; and a second concave edge at a second lateral side of the accessory.

### CROSS-REFERENCE TO RELATED APPLICATION

This application is a continuation-in-part of U.S. non-provisional application Ser. No. 14/333,445, filed Jul. 16, 2014, the disclosure of which is hereby incorporated by reference in its entirety.

### BACKGROUND OF THE INVENTION

Millions of people worldwide use portable electronic devices on a daily basis, and the prevalance of such devices is constantly increasing. An individual may have several devices with different primary functions and degrees of portability: music players, smart phones, tablets, electronic readers, gaming devices, etc. Many of these devices are trending towards sleeker designs and slimmer profiles, and many are extremely slick. Many devices can slip very easily out of a user's hand or off a lap during use, or even out of a garment pocket when not in use.

An entire industry has developed around corner bumpers and full cover cases for such devices. The bumpers and cases can protect electronic devices from scratches and impacts. Some can contribute to the device's aesthetics, or have a unique color or appearance to help the owner identify his or her device at a glance. However, many cases suffer from the same slickness as the bare devices do.

Furthermore, the cases add appreciable weight and bulk to the device—some are as heavy as the device itself. Some cases are rather expensive. Each case is typically only suited for a particular make and model of device, since all devices have different dimensions. Thus, if a user upgrades his or her device, a new case must be purchased as well, usually at a substantial cost.

While some cases address the issue of the slickness of the device which they are intended to protect, there is a still a need for a product that provides better grip to either a bare device or a case, without adding significant bulk or weight, ideally at a low cost.

Since smart phones were introduced in 2007, Americans have spent $5.9 billion dollars repairing damaged phones. The leading reported causes of accidents are (1) Phone being dropped from a user's hand, (2) Phone falling into a toilet, swimming pool, or lake, (3) Phone being dropped from a user's lap, (4) Phone being knocked off a table, (5) Phone being drenched by some liquid. These causes relate to smart phones that were produced between 2007 and 2014, which are generally smaller and more easily held than some of the newer versions being introduced recently.

Some manufacturers have recently introduced smart phones that, while still slim and sleek, have a much larger screen to facilitate web browsing, email functionality, and the like. With a larger screen comes a larger plan view size of the phone and more difficulty holding the phone, particularly with one hand. As of summer/fall 2014, the screen size and thus the area of phones seems to be trending larger, with more and more major manufactures jumping on the “phablet” bandwagon.

These new phablets are beyond the normal grasp. For instance, taking “selfies” makes a user particularly vulnerable to dropping the phone. A normal hand cannot grasp these big phones securely with one hand, scroll through emails, or push the shutter button to take a selfie while holding the phone with one hand.

One major manufacturer has attempted to address this issue by adding a gesture called “reachability,” which makes the top portion of the display move down toward the bottom when a user gently double-taps the home button. However, early testers have noted that even with “reachability,” it is more difficult to use a larger phone with one hand than its smaller predecessors. It also feels unnatural to hold a large phone up to one's ear during a call.

### BRIEF SUMMARY OF THE INVENTION

An accessory for a device defining a medial-lateral X direction, a proximal-distal Y direction generally transverse to the X direction, and an anterior-posterior Z direction generally transverse to the X and Y directions. The accessory includes a main body defining a substantially flat posterior surface in an X-Y plane, the surface being configured for attachment to the device. In a plan view when viewed from the Z direction, the main body defines a shape which includes a first concave edge at a first lateral side of the accessory; and a second concave edge at a second lateral side of the accessory.

### BRIEF DESCRIPTION OF THE DRAWINGS

Exemplary embodiments will be described in more detail with reference to the accompanying drawings, in which:

FIG. 1 is a plan view of an exemplary gripping accessory.

FIGS. 2A and 2B are a side and an end elevation view, respectively, of the accessory of FIG. 1.

FIGS. 3A-3C are cross-sectional views of the accessory, taken along line IIIA-IIIA, IIIB-IIIB, and IIIC-IIIC, respectively, in FIG. 1.

FIG. 4A is a perspective view of the accessory.

FIG. 4B shows an exemplary configuration of the accessory, once the accessory has been attached to a handheld device.

FIGS. 5A and 5B are a back view and a front view, respectively, of a handheld device in portrait orientation, where the handheld device has an accessory attached thereto.

FIGS. 5C and 5D are a back view and a front view, respectively, of a handheld device being held by a user in landscape orientation, where the handheld device has an accessory attached thereto.

FIGS. 6A-6E, 7A-7E, 8A-8B, 9A-9B, 10A-10B, 11, 12A-12F, 13-15, and 16A-16D are plan views of alternative embodiments of an accessory.

### DETAILED DESCRIPTION OF THE INVENTION

Exemplary embodiments of the presently disclosed invention provide a slim, adhesive-coated gripping accessory for attachment to handheld devices. The flat back surface is coated with an adhesive, configured to be adhered to a surface of a handheld device, so that the accessory can be adhered to the handheld device in any desired position, orientation, and number. In plan view, the accessory generally resembles an X shape, with four outwardly extending arms connecting at a generally central vertex or middle section, with two smaller cross-bars joining distal ends of the arms. Four feet may further be included: one at the distal end of each arm. The accessory is shaped and sized to be held comfortably by a user's four fingers on one side of the handheld device, while the thumb wraps around the other side of the device. The accessory is symmetrical, so it can be used by left- and right-handed users alike. The accessory is slim in the direction perpendicular to the surface of the electronic device, so as not to add appreciable bulk to the size of the device. In other words, when attached, it projects slimly away from the surface to which it is attached.

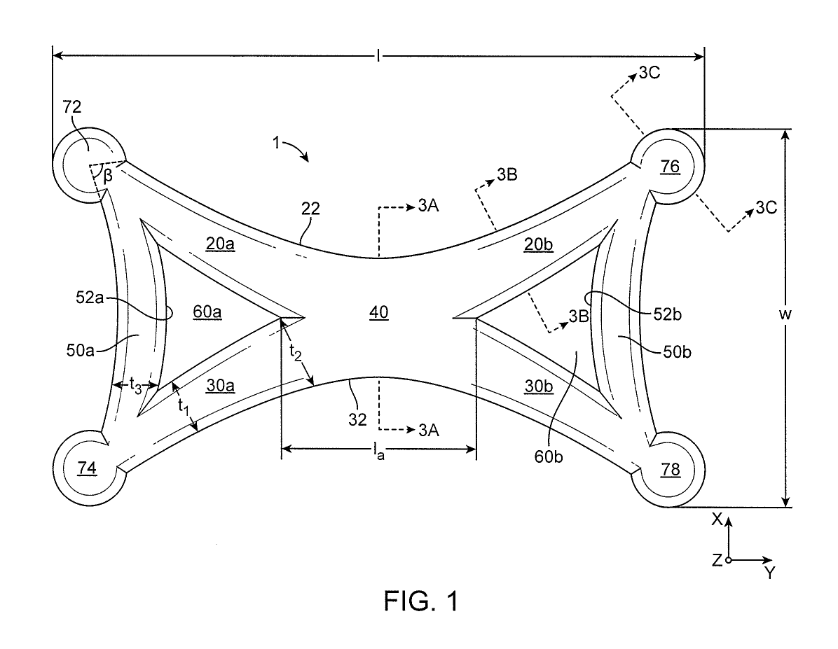

In more detail, in plan view, as illustrated in FIG. 1, the accessory 1 generally resembles a X shape with additional cross bars and rounded feet. The X shape includes four gently curving outwardly extending arms 20a, 20b, 30a, 30b, connected at a generally central vertex 40 (analogous to the elbow in the parent application) to define a middle section 40. Each pair of arms 20a and 20b, 30a and 30b presents a concave curve 22, 32 toward the edge of the accessory 1 and thus toward the edge of the handheld device to which the accessory is adhered.

In still more detail, the accessory 1 generally resembles two of the generally boomerang-shaped arcuate accessories described in the parent application, integrated together at the elbow of each, and with the addition of the cross bars 50a, 50b. While the accessory 1 is described herein in terms of several separate pieces, in a presently preferred embodiment, it consists of a single, integral, monolithic piece. The different portions of the accessory are described as such solely for ease of description and, where appropriate, for consistency with the terminology of the parent application.

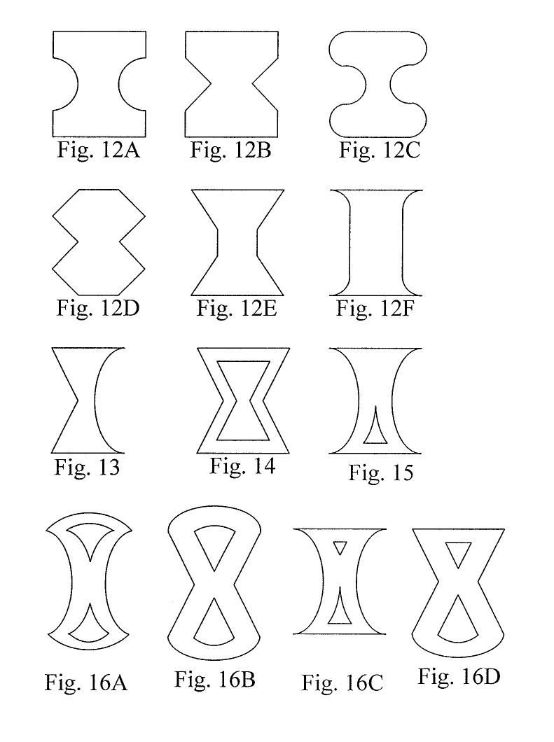

The shape of the accessory 1 was inspired by the configuration shown in FIG. 6K of the parent application, in which a concave surface is presented toward either edge of the device, and by the size of a typical phablet relative to a human hand. The size of a phablet lends itself to the hand reaching more than halfway across the back of the phablet, but it is too large to reach all the way across and grasp the far edge, particularly when typing with only the thumb.

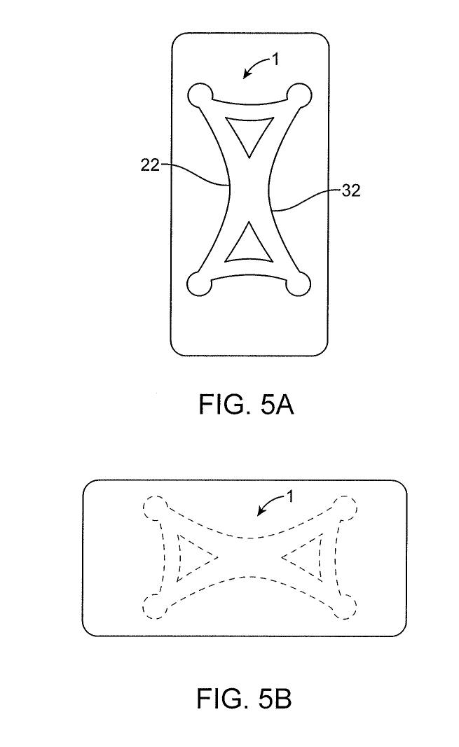

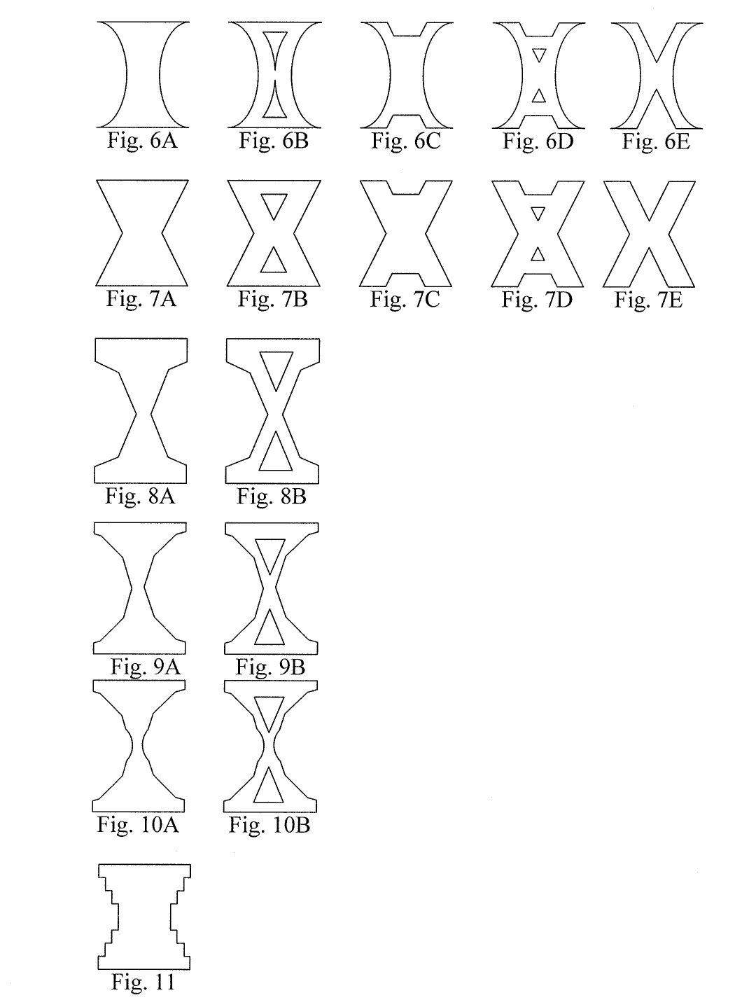

One aspect of the design of the exemplary, illustrated inventive “X” shape involves dimensions and an overall configuration that maximize ergonomic concerns regarding grip. Referring to FIG. 5A, when the device is held in the portrait orientation, the inner concave curve 22, 32 near the center of each side of the accessory allows the user's middle finger to dominate the hold with strength, by being located farthest toward the farther edge of the device (away from the edge around which the user's hand wraps). The descending wider angles farther along the longer arcuate portions allow the middle finger grip to be supplemented with the support of the shorter ring finger and index finger on each side. The feet allow the little finger to slide and pivot along the plane of the handheld device to position and orient the device to which the accessory 1 is attached.

The thumb will typically wrap around the device to provide support on the front side.

In a presently preferred embodiment, a single accessory 1 is packaged and sold individually. While in the package, the adhesive on the bottom surface 10 may be covered by a backing, e.g. paper. Alternatively, the accessory 1 is temporarily adhered to the packaging material itself (e.g., a sheet of plastic, slick cardboard, or plastic-coated cardboard), and the packaging and accessory may then be encased, e.g. in shrink wrap.

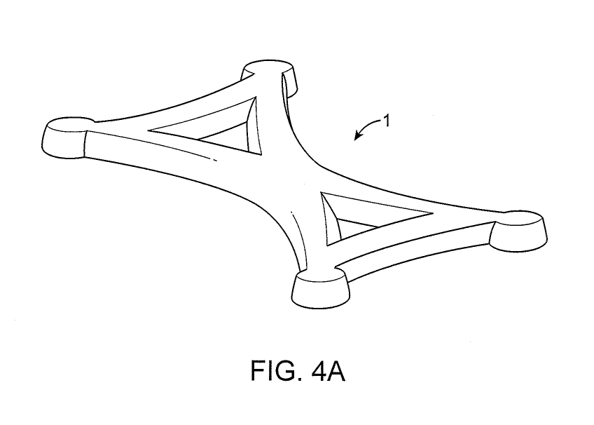

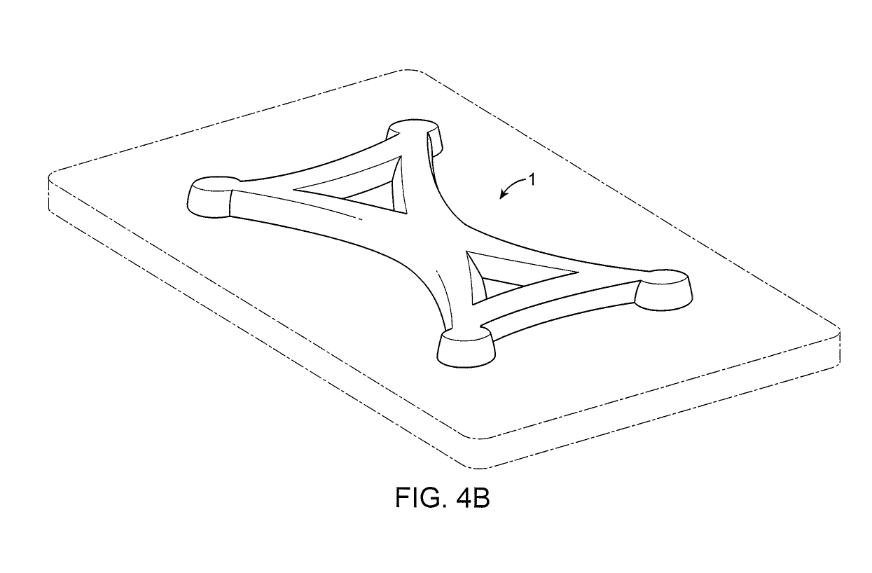

To apply the accessory 1 to a device, the user removes the backing from the accessory, or peels the accessory off the packaging, and then applies any desired number of accessories 1 in any desired configuration on the back surface of the device. An exemplary configuration is seen in FIG. 4B, which shows the presently preferred dimensions of the accessory relative to approximate dimensions of a standard “phablet” or large smart phone.

The embodiment of FIGS. 1-5D has a thick, substantial middle section when the phone is held vertically (in the portrait orientation), which optimizes its usefulness. This allows the user to do three things: (1) hold the phone securely with the ring, middle and index finger, (2) place the little finger under the bottom of the phone to keep it from slipping downward, and (3) use the free thumb to actuate the touch screen on the front of the handheld device.

The cross bars 50a, 50b strengthen the accessory, and provide the windows 60a, 60b near each end, allowing for a finger hold from inside the window when holding the phone in the horizontal (landscape) configuration seen in FIGS. 5C and 5D. This element also adds choice to the way the electronic device can be gripped, giving the user more confidence as the device is switched from portrait to landscape orientation, from hand to hand, and when placed down on a surface.

The feet 72, 74, 76, 78, similar to those in the parent application, may have any suitable shape, such as being wider (in plan view) than the local width of the arms 20a, 20b, 30a, 30b, as illustrated. In the illustrated embodiments, the feet are substantially circular in plan view, however, they may be any desired shape, such as any shape that may assist the user to move the position and/or orientation of the device to which the accessory 1 is attached with his or her pinky finger, as is described in detail in the parent application. Alternatively, the feet may be omitted entirely, and the arms may simply terminate, such as at respective rectangular or rounded ends.

The embodiment of FIGS. 1-5D is mirror-symmetrical in the X-direction with a Y-Z plane of symmetry across the center of the accessory. This allows the accessory 1 to be used in the portrait orientation regardless of whether the user is left- or right-handed, which facilitates purchasing and application of the accessories to the device, and allows device owners to share their devices with family and friends.

The embodiment of FIGS. 1-5D is also mirror-symmetrical in the Y direction with a X-Z plane of symmetry across the center of the accessory. This allows the accessory 1 to be used in the landscape orientation regardless of whether the user is left- or right-handed, which facilitates purchasing and application of the accessories to the device, and allows device owners to share their devices with family and friends.

The overall length l of the accessory may be approximately 3.5″. The width w may be approximately 2.0″. The thickness t₁ of each arm near its distal end may be approximately 0.25″. The thickness t₂ at the point at which the arms join each other may be approximately 0.38″. The thickness t₃ of the cross bars may be approximately 0.25 inches. This thickness t₃ may be constant across the entire length of the respective cross bar 3. The diameter d of each foot may be approximately 0.40″, and each foot may consist of approximately 4/5 of a circle (or more accurately, approximately 78% of a circle), because the angle 13 traversed by the arm is approximately 79 degrees.

The arms may intersect over a distance lₐ of approximately 1.0″ of their lengths, i.e. slightly less than a third of the length l of the accessory, and over a width wₐ approximately 0.625″ of width. On either side of the intersecting section near the vertex 40, an approximately triangular (or approximately deltoid-shaped) window or cutout 60a, 60b is defined.

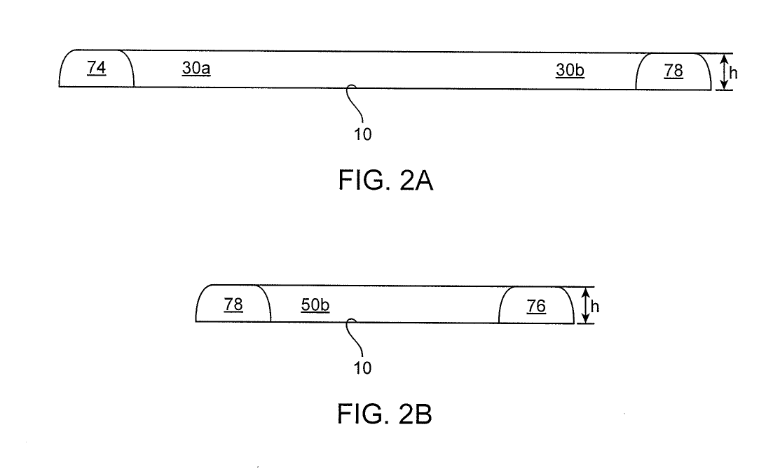

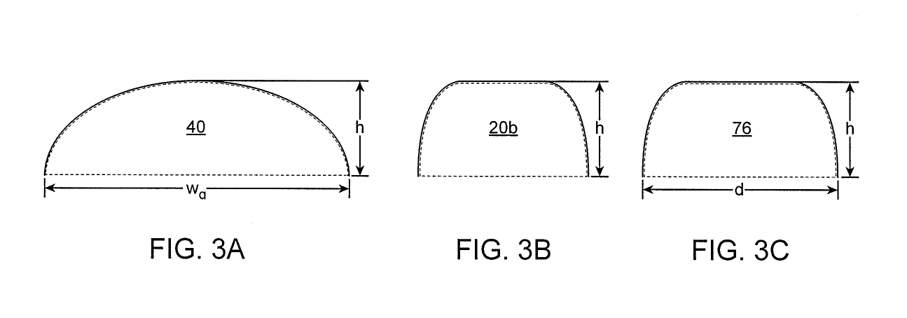

Having described the shape of the accessory 1 in plan view, let us turn now to FIGS. 2A-2B, 3A-3C, and 4A, to describe its three-dimensional shape. As is seen in FIG. 3C, the cross-section taken along line IIIC-IIIC in FIG. 1 may be approximately rectangular, with sharp bottom corners and rounded top corners, as shown. As seen in FIG. 3B, the cross-section taken along line IIIB-IIIB in FIG. 1 may be more rounded, such as the approximately semi-elliptical shape shown, and as seen in FIG. 3A, the cross-section taken along line IIIA-IIIA may be more rounded still. These shapes can also be seen in perspective view in FIG. 4A.

Referring to the side and end views of FIGS. 2A and 2B, respectively, the height h may be constant across the entire accessory 1. In a presently preferred embodiment, the height h is approximately 0.19″ ( 3/16″).

### Alternative Plan View Shapes

It will be appreciated from the foregoing that the heretofore described embodiment of the accessory distinguishes over the accessory of the parent application in at least two aspects: first, it presents two concave edges 22, 32 at lateral sides thereof; and second, it presents two additional edges 52a, 52b near distal sides thereof which are absent in the exemplary accessory of the parent application. While the presently preferred embodiment described above implements these features with the specific modified X-shape (in plan view) shown in FIGS. 1-5D, these features can alternatively be implemented in a variety of alternative embodiments. Some exemplary alternative embodiments are illustrated in FIGS. 6A-16D.

First, the concave edges need not be the smooth curves shown, but can be any edge that presents a concave shape toward the edge of the device. For example, the concave edge as is seen in FIGS. 6A-6E is similar to that of the heretofore described embodiment, in that it is a single smooth curve. The concave edge of FIGS. 7A-7E, on the other hand, is two straight line segments that join at a sharp corner. The concave edges need not be curved, as can be seen in FIGS. 7A-7E, but can instead be concave polygonal surfaces, or any combination of curves, straight lines, sharp corners, and rounded corners. The hollow defined laterally of the edges in FIGS. 7A-7E is generally a concave triangle, and thus, the edge as a whole can be considered concave. Taking this concept even further, we see in FIGS. 8A, 8B, 9A, and 9B that the concave edges can define any concave polygon. Regular octagons are seen in FIGS. 8A and 8B, and regular dodecagons are seen in FIGS. 9A and 9B. Additionally, a combination of straight line segments and curves can be used as the concave edge. A dodecagon with a rounded inner portion is seen in FIGS. 10A and 10B. Any and all of these shapes should be understood to fall within the scope of the term “concave edge.”

Further yet, referring to FIG. 11, the concavity of the concave edge can also be approximated by line segments that are not individually concave, but which work together to approximate a concavity. The relative sizes of the line segments relative to typical fingers should be considered here: a straight line segment in the Y direction that is shorter than a typical finger is wide can be considered part of a concave edge, as is seen in one specific embodiment in FIG. 11.

Still further, not the entire edge must necessarily be concave, as is seen in FIGS. 12A-12F. FIGS. 12A-12D show examples in which only the central portion of the edge is concave, and FIGS. 12E and 12F show examples in which only the distal portions of the edge are concave.

FIGS. 6A and 6B define what may be referred to as an hourglass shape, FIGS. 7A and 7B define what may be referred to as a bowtie shape, FIGS. 6C, 6D, 7C, and 7D define what may be referred to as a dual A shape, and FIGS. 6E and 7E define what may be referred to as an X shape. FIGS. 8A, 8B, 9A, 9B, 10A, 10B, 11 and 12A-12F may be considered embellishments of these general shapes.

It will be appreciated that the accessory does not necessarily need to be symmetric, as is shown in one specific example in FIG. 13.

FIGS. 6A, 6C, 6E, 7A, 7C, 7E, 8A, 9A, 10A, 11, 12A-12F, and 13 illustrate exemplary embodiments which do not include windows 60a, 60b and thus do not include the two additional edges 52a, 52b. FIGS. 6B, 6D, 7B, 7D, 8B, 9B, and 10B are similar to FIGS. 6A, 6C, 7A, 7C, 8A, 9A, and 1 OA, respectively, but include the addition of windows and thus of additional edges which may in some embodiments be gripped when the device is held in landscape orientation.

Furthermore, in some embodiments, the accessory includes only one window rather than two as shown in FIGS. 14 and 15 (FIG. 14 showing an embodiment that still includes the two additional edges 52a and 52b, and FIG. 15 showing an alternative embodiment with only one additional edge 52a), or any number of three or more windows if desired.

The additional edges presented by the windows may have any desired shape, as is illustrated in FIGS. 6B, 6D, 7B, 7D, 8B, 9B, 10B, 14, 15, and 16A-16D. For example, the additional edges may be linear (6B, 6D, 7B, 7D, 8B, 9B, 10B, 14, 15, 16C, and the upper edge of FIG. 16D). Alternatively, the additional edges may also be concave edges to allow the advantages of a concave edge as is discussed above and as is discussed in detail in the parent application. This is seen in FIGS. 16A and 16B, and the bottom edge of FIG. 16D. In a further alternative, the additional edges may be convex as was seen in the first disclosed embodiment of FIGS. 1-5D.

In embodiments with two windows and/or two edges, the windows and/or edges need not be symmetric with one another as is seen in FIGS. 16C and 16D. In other words, FIG. 16C shows two windows that are not symmetric with one another, but two additional edges that are symmetric with one another. FIG. 16D shows two asymmetric windows defining two asymmetric additional edges.

While feet are not illustrated, any number of feet could be added to any number of the corners of the shapes shown in FIGS. 6A-16D. The shapes shown in FIGS. 6A-16D are presented for exemplary purposes only to illustrate only some of many alternative shapes that may fall within the scope of the attached claims, and particularly to provide guidance as to exemplary meanings of the terms “concave,” “edge,” “concave edge,” and “window,” without limiting these terms.

The presently preferred embodiment is made primarily of a soft material that may provide some protection against impact to the device. The presently preferred embodiment is additionally or alternatively made primarily of a material that imparts a higher coefficient of friction to a user's fingers than the device surface alone would. A presently preferred material is silicone, but other materials are within the scope of the present invention. The presently preferred embodiment may be molded as a single, integral piece (other than the adhesive on the back surface). The presently preferred embodiment is made of clear silicone, but other materials, colors, etc. are within the scope of the present invention.

It will be appreciated based on the foregoing that exemplary embodiments of the inventive accessories are low-cost, light-weight, easy to apply, and do not add appreciable bulk to the device on which they are used. The height h is just thick enough to effectively provide a surface tall enough to allow the user's fingers to effectively support the device with a pressing force in the X or Y direction when the device is held in the portrait or landscape orientation, respectively. The height h also ensures that the accessory 1 will touch flat surfaces first, which may, in embodiments in which the material of the accessory has a higher coefficient of friction than the device surface, prevent the device from sliding when being set down. The overall configuration and dimensions of the specific embodiments shown allow the middle finger to provide a centered grip with the most pressure near the center of the accessory, when the device is held in the portrait orientation. The index and ring fingers apply secondary pressure, while the little finger is used to adjust the angle of the device while it is being held, by pivoting the device about the middle finger. The shape and dimensions of the rounded feet of the particular embodiments shown are particularly suitable for the fit of the little finger as it is used to angle the device. The cross bars and deltoid-shaped windows also allow for a sturdy grip when the accessory is in the landscape orientation. Thus, the accessory may benefit the user when carrying the device, when holding it for use in either the portrait or the landscape orientation, and/or when setting it down on a desk or table, and may even prevent the device from slipping out of garment or purse pockets by providing a higher overall coefficient of friction than a bare device and most cases.

Still further, exemplary embodiments of the inventive accessories may strengthen some of the newer phones which are so thin as to be quite fragile in twisting.

As will be understood by those skilled in the art, the present invention may be embodied in other specific forms without departing from the essential characteristics thereof. Many other embodiments are possible without departing from the essential characteristics thereof. Many other embodiments are possible without deviating from the spirit and scope of the invention. These other embodiments are intended to be included within the scope of the present invention, which is set forth in the following claims.

What is claimed is:

1. An accessory for a device, defining a medial-lateral X direction, a proximal-distal Y direction generally transverse to the X direction, and an anterior-posterior Z direction generally transverse to the X and Y directions, the accessory comprising:
a main body defining a substantially flat posterior surface in an X-Y plane, the surface being configured for attachment to the device;
wherein, in a plan view when viewed from the Z direction, the main body defines a shape comprising:
a first concave edge at a first lateral side of the accessory; and
a second concave edge at a second lateral side of the accessory.

2. The accessory of claim 1, where the shape further comprises a first cut-out defining a first cut-out shape in plan view, the first cut-out shape comprising a first additional edge that is proximal from a first distal edge of the accessory.

3. The accessory of claim 2, where the shape further comprises a second cut-out defining a second cut-out shape in plan view, the second cut-out shape comprising a second additional edge that is proximal from a second distal edge of the accessory.

4. The accessory of claim 1, wherein the plan view shape further comprises a first, a second, a third, and a fourth foot connected to lateral, distal corners of the accessory, wherein each foot has a larger width than a local width of the accessory adjacent the corner, wherein the widths of the feet and the local widths of the accessory are defined in a width direction lying in the X-Y plane.

5. The accessory of claim 4, wherein each foot is substantially circular in the plan view, and wherein the width of each foot is a diameter of the corresponding foot.

6. The accessory of claim 1, wherein the accessory is substantially mirror-image symmetric, wherein a plane of symmetry of the accessory is a Y-Z plane disposed at a medial portion of the accessory.

7. The accessory of claim 1, wherein the accessory is substantially mirror-image symmetric, wherein a plane of symmetry of the accessory is n X-Z plane disposed at a proximal portion of the accessory.

8. The accessory of claim 1, wherein the accessory is made in the form of a single integral, monolithic piece.

9. The accessory of claim 1, comprising silicone.

10. The accessory of claim 1, further comprising an adhesive on the surface, configured for attachment to the device.

11. An accessory for a device, comprising a shape in plan view generally defining an X shape, the X shape comprising a first, a second, a third, and fourth outwardly extending arm, the arms joining one another at a generally central vertex, wherein the first and second arms cooperate to define a first concave edge, wherein the third and fourth arms cooperate to define a second concave edge, the accessory further defining a flat surface configured for attachment to a device, the accessory being configured and dimensioned for at least two of a user's fingers to extend across the X shape, traversing the first concave edge and being placed interior to the second concave edge, to apply a holding force to the device.

12. The accessory of claim 11, wherein the at least two fingers comprise an index finger, a middle finger, and a ring finger of a single one of the user's hands.

13. The accessory of claim 12, wherein the accessory is configured and dimensioned for the middle finger to grip the accessory near the vertex, and for the index and middle fingers to grip respective ones of the arms.

14. The accessory of claim 12, further comprising at least one foot at a distal end of at least one of the arms, the foot being configured, dimensioned, and located to be gripped by a pinky of the hand.

15. The accessory of claim 14, wherein the at least one foot comprises a first, a second, a third, and fourth foot, at distal ends of the first, second, third, and fourth arms, respectively.

16. The accessory of claim 11, wherein the accessory is substantially mirror-image symmetric, wherein a plane of symmetry of the accessory is disposed at the vertex and extends in a plane generally transverse to the flat surface.

17. The accessory of claim 11, wherein the shape further comprises a first cross bar connecting distal portions of the first and third arms.

18. The accessory of claim 17, wherein the first cross bar, the first arm, and the third arm cooperate to define a generally triangular cutout.

19. The accessory of claim 17, wherein the shape further comprises a second cross bar connecting distal portions of the second and fourth arms.

20. The accessory of claim 19, wherein the first cross bar, the first arm, and the third arm cooperate to define a first generally triangular cutout; and wherein the second cross bar, the second arm, and the fourth arm cooperate to define a second generally triangular cutout.
